(19) United States
(12) Patent Application Publication
(10) Pub. No.: US 2007/0255864 A1
(43) Pub. Date: Nov. 1, 2007

(54) Information transfer apparatus and information transfer method

(75) Inventor: Minoru Moriwaki, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/705,717

(22) Filed: Feb. 14, 2007

(30) Foreign Application Priority Data
Apr. 28, 2006 (JP) 2006-127040

(51) Int. Cl. G06F 13/28

(52) U.S. Cl. 710/22

(57) ABSTRACT

According to one embodiment, an information transfer apparatus for performing direct memory access (DMA) between a memory unit and an input/output device comprises a first port to form a first transfer path which performs DMA transfer of information between the memory and the input/output device via a general-purpose bus, a second port to form a second transfer path which directly performs DMA transfer of information between the memory unit and the input/output device no via the general-purpose bus, and a selecting unit to select the first transfer path and the second transfer path on the basis of control from the outside.

### CROSS-REFERENCE TO RELATED APPLICATIONS

This application is based upon and claims the benefit of priority from Japanese Patent Application No. 2006-127040, filed Apr. 28, 2006, the entire contents of which are incorporated herein by reference.

### BACKGROUND

1. Field

One embodiment of the invention relates to an information transfer apparatus and an information transfer method for performing direct memory access (DMA) transfer of information of, for example, video images and audio, etc.

2. Description of the Related Art

As is known well, when performing the DMA transfer of signals of video images and audio between a memory and an input output (IO) device via a general-purpose bus, such as a peripheral component interconnect (PCI) bus, its transfer speed being decided in accordance with a transfer capability of the bus, it is impossible to expect high-speed transfer higher than the transfer capability thereof.

A technique, which decides priorities of executions of the DMA transfer from a plurality of ports, executes interruptions of the DMA transfer from the ports with high priorities, and arbitrates the DMA transfer so as to enable continuously executing DMA transfer even from the ports with low priorities without perfectly interrupting it, is disclosed by Jpn. Pat. Appln. KOKAI Publication No. 2005-267251.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram illustrating one embodiment of the present invention, and illustrating and explaining a summary of an optical disk reproduction device;

FIG. 2 is an exemplary block diagram illustrating and specifically explaining a DMA transfer means of the optical disk reproduction device in the embodiment;

FIG. 3 is an exemplary block diagram illustrating and explaining one example of a DMA controller used for the DMA transfer means of the optical disk reproduction device in the embodiment;

FIG. 4 is an exemplary flowchart illustrating and explaining one example of main processing operations of the DMA transfer means of the optical disk reproduction device in the embodiment; and

FIG. 5 is an exemplary block diagram illustrating and practically explaining the DMA transfer means of the optical disk reproduction device in the embodiment.

### DETAILED DESCRIPTION

Various embodiments according to the invention will be described hereinafter with reference to the accompanying drawings. In general, according to one embodiment of the invention, an information transfer apparatus for performing direct memory access (DMA) between a memory unit and an input/output device comprises a first port to form a first transfer path which performs DMA transfer of information between the memory and the input/output device via a general-purpose bus, a second port to form a second transfer path which directly performs DMA transfer of information between the memory unit and the input/output device no via the general-purpose bus, and a selecting unit to select the first transfer path and the second transfer path on the basis of control from the outside.

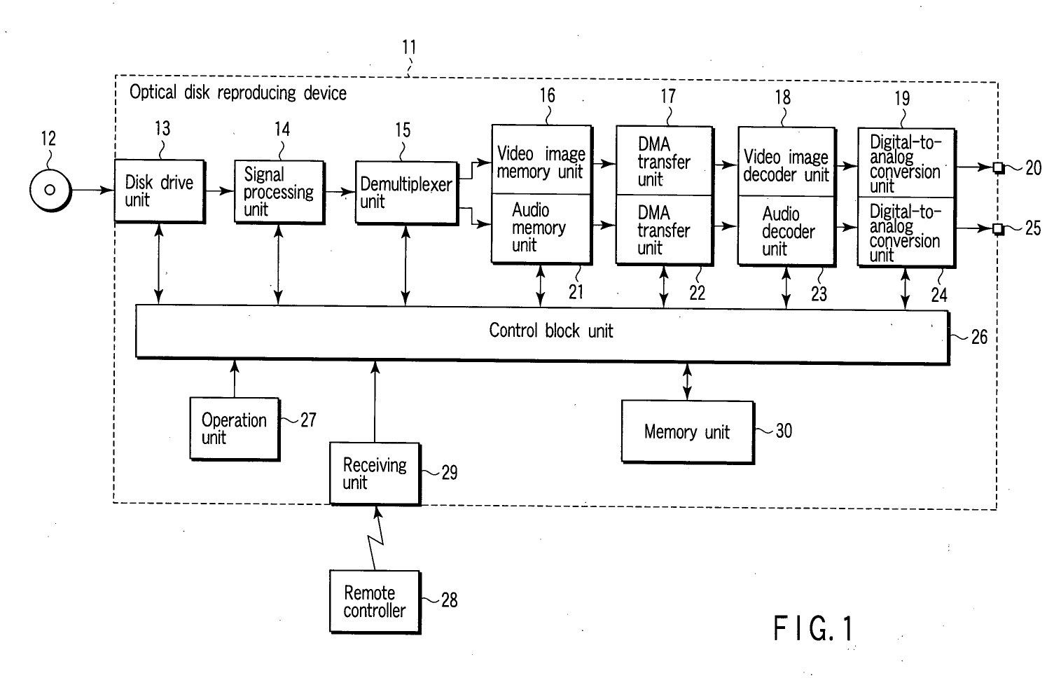

FIG. 1 shows an optical disk reproduction device 11 as one example of a system with a DMA transfer means. The reproduction device 11 has, for instance, a disk drive unit 13 to and from which an optical disk 12, such as a digital versatile disk (DVD), is attachable and detachable.

The disk drive unit 13 reads out an information stream recorded thereon, from the mounted optical disk 12. The information stream read out by the disk drive unit 13 is performed prescribed digital signal processing by means of a signal processing unit 14 then supplied to a demultiplexer unit 15 to separate into a video image stream and a audio stream.

A video image memory unit 16 stores the video image stream. The video image stream stored in the video image memory unit 16 is transferred to a video image decoder unit 18 through a DMA transfer unit 17 to be processed by decode processing, then, converted into analog video image signals by a digital-to-analog conversion unit 19 to be extracted from an output terminal 20.

A audio memory unit 21 stores the audio stream separated by the demultiplexer unit 15. The audio stream stored in the audio memory unit 21 is transferred to a audio decoder unit 23 through a DMA transfer unit 22 to be processed decode processing, then, converted into analog audio signals by a digital-to-analog conversion unit 24 to be extracted from an output terminal 25.

Here, whole operations including the aforementioned reproduction operations of the reproduction device 11 are integrally controlled by a control block unit 26. The control block unit 26 has a central processing unit (CPU). Etc., built-in, receives operation information from an operation unit 27, or operation information from a remote controller 28 through a receiving unit 29, and controls each unit, respectively, so that the operation contents are reflected.

In this case, the control block unit 26 utilizes a memory unit 30. The memory unit 30 mainly has a read only memory (ROM) with a control program to be executed by the CPU stored therein, a random access memory (RAM) providing an operation area to the CPU, and a nonvolatile memory to store each kind of setting information, control information, etc.

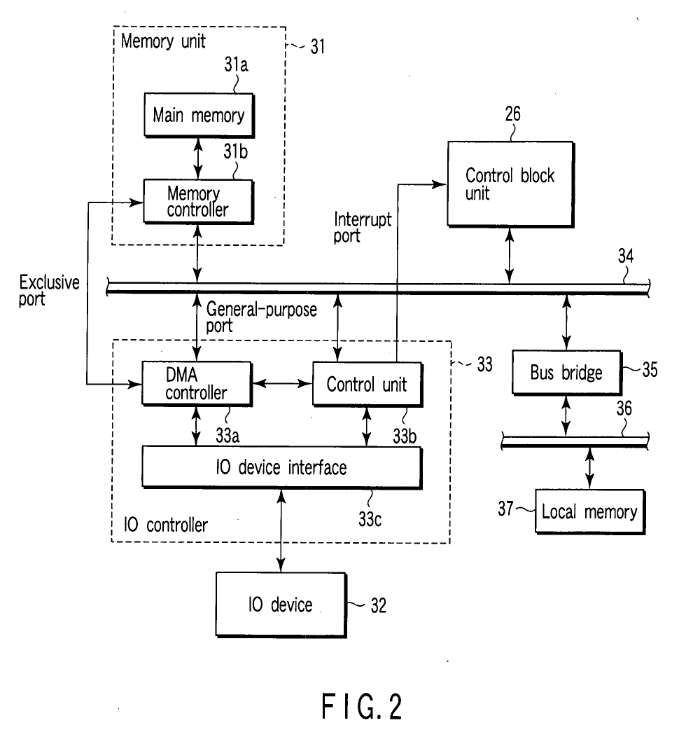

FIG. 2 shows the DMA transfer means specifically. Corresponding to the reproduction device 11 shown in FIG. 1, a memory unit 31 consisting of a main memory 31a and a memory controller 31b, in FIG. 2, corresponds to the video image memory unit 16 and audio memory unit 21.

In FIG. 2, an IO device 32 corresponds to the video image decoder unit 18 and the audio decoder unit 23. Further, in FIG. 2, an IO controller 33 consisting of a DMA controller 33a in a bus master system, a control unit 33b and an IO device interface 33c corresponds to the DMA transfer units 17 and 22, respectively.

The memory controller 31b of the memory unit 31 is connected to a general-purpose bus 34. The control block unit 26 is connected to the general-purpose bus 34. Further, the control unit 33b of the IO controller 33 is connected to the general-purpose bus 34 and also directly connected to the control block unit 26 though an interruption port.

The DMA controller 33a of the IO controller 33 has a general-purpose port and an exclusive port, the general-purpose port is connected to the general-purpose bus 34, and the exclusive port is directly connected to the memory controller 31b of the memory unit 31. Furthermore, the IO device interface 33c of the IO controller 33 is connected to the IO device 32.

The general-purpose bus 34 is connected to other general-purpose bus 36 through a bus bridge 35, and the general-purpose bus 36 is connected to a local memory 37.

In such configuration, the control block unit 26 is possible to access the main memory 31a via the general-purpose bus 34 and the memory controller 31b of the memory unit 31. The control block unit 26 can access the IO device 32 through the general-purpose bus 34, the control unit 33b and IO device interface 33c of the IO controller 33. The control block unit 26, moreover, is possible to access the local memory 37 via the general-purpose bus 34, bus bridge 35 and general-purpose bus 36.

Thereby, in the system, data (information) transfer has become possible among the memory unit 31, IO device 32 and the local memory 37 with one another.

Meanwhile, when accessing the IO device 32, as described above, if the control block unit 26 uses a method for accessing the IO device 32 via the IO controller 33, because the control block unit 26 has accessed the IO device 32 having a speed lower than its processing speed, a load results in imposing on the control block unit 26 and the performance of the system results in reducing.

Therefore, in accessing the IO device 32, a method for reducing the load imposed on the control block unit 26 uses the DMA controller 33a. The control block unit 26 operates the DMA controller 33a instead of directly performing data transfer to and from the IO device 32, and makes the DMA controller 33a conduct the data transfer between the memory unit 31 or local memory 37 and the IO device 32. The control block unit 26, thereby, only accesses the high-speed memory unit 31 or the local memory 37, then; it becomes possible to also use the data on the IO device 32 and to prevent performance reduction in the system.

The DMA transfer between the memory unit 31 and the IO device 32 is implemented via a path or its reverse path which reaches the IO device 32 via the main memory 31a, memory controller 31b, general-purpose bus 34, and the general-purpose port and IO device interface 33c of the DMA controller 33a.

The DMA transfer between the local memory 37 and the IO device 32 is performed via a path or its reverse path which achieves the IO device 32 via the local memory 37, general-purpose bus 36, bus bridge 35, general-purpose bus 34, and the general-purpose port and IO device interface 33c of the DMA controller 33a.

Meanwhile, in recent years, the processing speed of the IO device 32 has increased; resulting from such situation, the IO controller 33 is also required to adopt an architecture to which an increase in processing speed is taken into account. The aforementioned DMA transfer between the memory unit 31 or local memory 37 and the IO device 32 performs the data transfer via the general-purpose bus 34 in either case. In such case, the transfer capability of the general-purpose bus 34 becoming a factor to decide the processing speed of the system, it has become impossible to expect transfer with a processing speed higher than that of the general-purpose bus 34.

In the present embodiment, thus; as described above, the DMA controller 33a of the IO controller 33 has the general-purpose port and exclusive port, and directly connects the exclusive port to the memory controller 31b of the memory unit 33. The direct data transfer via the exclusive port can be performed without using the general-purpose bus 34 between the DMA controller 33a and the memory controller 31b.

Therefore, by using the exclusive port, the DMA transfer means can increase the DMA transfer speed between the main memory 31a and the IO device 32 in comparison with the DMA transfer speed in the case of transfer through the general-purpose bus 34. The DMA transfer means conducts the DMA transfer between the local memory 37 and the IO device 32 via the general-purpose bus 34. That is, the DMA transfer means can easily improve the DMA transfer speed of a part in the system with a simple configuration without having to enhance the transfer capability of the general-purpose bus 34.

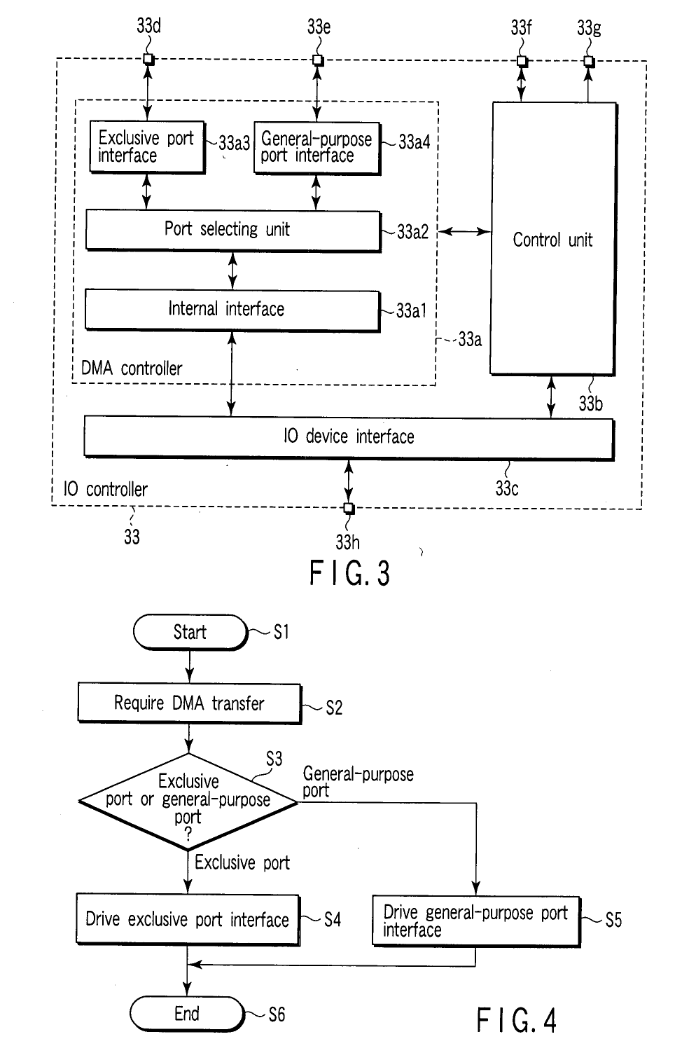

FIG. 3 shows one example of the DMA controller 33a. Namely, the DMA controller 33a is connected to the IO device interface 33c through an internal interface 33a1. The internal interface 33a1 is connected to a port selecting unit 33a2. The port selecting unit 33a2 drives either an exclusive port interface 33a3 or a general-purpose port interface 33a4 on the basis of an instruction from the control unit 33b. The exclusive port interface 33a3 is connected to the memory controller 31b through an exclusive port 33d. The general-purpose port interface 33a4 is connected to the general-purpose bus 34 through the general-purpose port 33e.

The control unit 33b is connected to the general-purpose bus 34 via an input/output port 33f to the general-purpose bus 34 and also connected to the control block unit 26 through an interruption port 33g. The IO device interface 33c is, moreover, connected to the IO device 32 via the input/output port 33h.

When an instruction to select the exclusive port is issued from the control block unit 26, the instruction is provided to the port selecting unit 33a2 through the general-purpose bus 34, input/output port 33f and control unit 33b. The port selecting unit 33a2 drives the exclusive port interface 33a3 on the basis of the instruction to select the exclusive port.

Thereby, the DMA transfer is performed between the memory unit 31 and the IO device 32 via a path or an its reverse path which reaches the IO device 32 through the main memory 31a, memory controller 31b, exclusive port 33d, exclusive port interface 33a3, port selecting unit 33a2, internal interface 33a1, IO device interface 33c and input/output port 33h.

When an instruction to select the general-purpose port is issued from the control block unit 26, the instruction is provided to the port selecting unit 33a2 through the general-purpose bus 34, the input/output port 33f and control unit 33b. The port selecting unit 33a2 drives the general-purpose port interface 33a4 on the basis of the instruction to select the general-purpose port.

Thereby, since the DMA controller 33a is connected to the general-purpose bus 34, the DMA transfer via the general-purpose bus 34 is performed between the memory unit 31 or the local memory 37, and the IO device 32.

FIG. 4 shows a flowchart in which one example of processing operations through which the IO controller 33 performs the DMA transfer by selecting either the exclusive port 33d or the general port 33e on the basis of the instruction from the control block unit 26 is put together. That is, the processing is started (step S1), in step S2, if a DMA transfer request is given from the control block unit 26, the control unit 33b of the IO controller 33 determines which of the exclusive port 33d and the general-purpose port 33e is specified in step S3.

If it is determined that the exclusive port 33d has been specified, the control unit 33b of the IO controller 33 controls so that the port selecting unit 33a2 drives the exclusive port interface 33a3 in step S4 to end the processing (step S6). If it is determined that the general-purpose port 33e is specified in step S3, the control unit 33b of the IO controller 33 controls so that the port selecting unit 33a2 drives the general-purpose port interface 33a4 in step S5 to end the processing (step S6).

In FIG. 3, in the case of issuing memory write as post write, when the last memory write is issued from the DMA controller 33a, the DMA controller 33a notifies a DMA completion to the control unit 33b, and the control unit 33b issues the interruption to the control block unit 26 through the interruption port 33g, then, the DMA controller 33a notifies the completion of the DMA transfer.

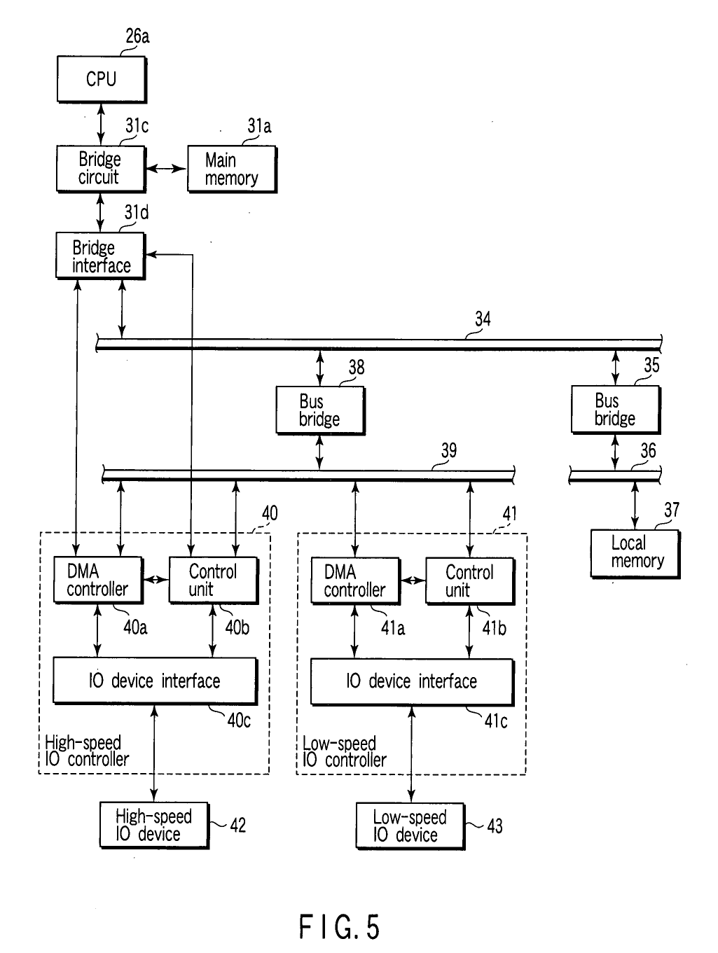

FIG. 5 practically shows the DMA transfer means shown in FIG. 2. In FIG. 5, a description about parts differing from FIG. 2 includes that the main memory 31a is connected to a bridge circuit 31c and a bridge interface 31d, the bridge circuit 31c is connected to a CPU 26a of the control block unit 26, and the bridge interface 31d is connected to the general-purpose bus 34.

The general-purpose bus 34 is connected to a general-purpose bus 39 through a bus bridge 38. A high-speed IO controller 40 and a low-speed IO controller 41 are connected to the general-purpose bus 39. The high-speed IO controller 40 has a DMA controller 40a, a control unit 40b and an IO device interface 40c corresponding to the DMA transfer unit 17.

The DMA controller 40a has an exclusive port and a general-purpose port, which are connected to the bridge interface 31d of the memory unit 31 and to the general-purpose bus 39, respectively. The control unit 40b is connected to the general-purpose bus 39 and also connected to the bridge interface 31d, and the IO device interface 40c is connected to a high-speed IO device 42 (corresponding to the video image decoder unit 18).

The low-speed IO controller 41 corresponds to the DMA transfer unit 22, and has a DMA controller 41a, a control unit 41b and an IO device interface 41c. The DMA controller 41a and the control unit 41b are connected to the general-purpose bus 39, and the IO device interface 41c is connected to a low-speed IO device 43 (corresponding to the audio decoder unit 23).

As shown in FIG. 5, the DMA controller 40a of the high-speed IO controller 40 is provided with exclusive ports directly connected to the memory unit 31 without through the general-purpose buses 34 and 39 so as to improve the DMA transfer speed between the memory unit 31 and the high-speed IO device 42. The high-speed IO device 42 also can selectively perform the DMA transfer to the memory unit 31, the local memory 37 and the low-speed IO device 43 via paths through each general-purpose bus 34, 36, 39, etc.

The low-speed IO device 43 may selectively make the DMA transfer to the memory unit 31, the local memory 37 and the high-speed IO device 42 through each general-purpose path 34, 36 and 39, etc.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information transfer apparatus for performing direct memory access (DMA) between a memory unit and an input/output device, comprising:
a first port to form a first transfer path which performs DMA transfer of information between the memory unit and the input/output device via a general-purpose bus;
a second port to form a second transfer path which directly performs DMA transfer of information between the memory unit and the input/output device not via the general-purpose bus; and
a selecting unit configured to select the first transfer path and the second transfer path on the basis of control form the outside.

2. The information transfer apparatus according to claim 1, wherein
the first port is connected to the general-purpose bus with the memory unit connected thereto; and
the second port is directly connected to the memory unit not via the general-purpose bus.

3. The information transfer apparatus according to claim 1, wherein
the selecting unit is configured to selectively connect the input/output device to the first port and
the second port so as to transfer the information.

4. The information transfer apparatus according to claim 1, further comprising:
a first interface which is connected to the first port to perform information transfer to and from the memory unit via the general-purpose bus;
a second interface which is connected to the second port to directly perform information transfer to and from the memory unit not via the general-purpose bus; and
a third interface to perform information transfer to and from the input/output device.

5. The information transfer apparatus according to claim 4, wherein
the selecting unit is configured to selectively connect the first interface and the second interface to the third interface.

6. The information transfer apparatus according to claim 4, wherein
the selecting unit is configured to selectively drive the first interface and the second interface.

7. The information transfer apparatus according to claim 1, wherein
the selecting unit is configured to perform a selecting operation on the basis of control from a control unit for controlling a system including the information transfer apparatus.

8. An information transfer method for performing direct memory access (DMA) transfer between a memory unit and an input/output device, comprising:
selectively forming a first transfer path which performs DMA transfer of information between the memory unit and the input/output device via a general-purpose bus, and a second transfer path which directly performs DMA transfer of the information between the memory unit and the input/output device not via the general-purpose bus on the basis of control from the outside.

9. The information transfer method according to claim 8, further comprising:
selectively connecting a first interface to perform information transfer to and from the memory unit via the general-purpose bus and a second interface to directly perform information transfer to and from the memory unit not via the general-purpose bus to a third interface to perform information transfer to and from the input/output device.

10. The information transfer method according to claim 9, further comprising:
determining which of the first and the second transfer paths is required on the basis of control from the outside;
connecting the first interface to the third interface when the first transfer path is required; and
connecting the second interface to the third interface when the second transfer path is required.
